(19) United States
(12) Patent Application Publication
(10) Pub. No.: US 2025/0321576 A1
(43) Pub. Date: Oct. 16, 2025

(54) REMOTE OPERATOR TERMINAL AND REMOTE ASSISTANCE SYSTEM

(71) Applicant: TOYOTA JIDOSHA KABUSHIKI KAISHA, Toyota-shi (JP)

(72) Inventors: Hiromitsu URANO, Numazu-shi (JP); Takefumi Goto, Gotemba-shi (JP); Hiromitsu Kobayashi, Nagoya-shi (JP)

(73) Assignee: TOYOTA JIDOSHA KABUSHIKI KAISHA, Toyota-shi (JP)

(21) Appl. No.: 19/049,402

(22) Filed: Feb. 10, 2025

(30) Foreign Application Priority Data
Apr. 10, 2024 (JP) 2024-063642

(51) Int. Cl. G05D 1/224; G05D 1/227

(52) U.S. Cl. CPC G05D 1/2245; G05D 1/2279

(57) ABSTRACT

A remote operator terminal for a remote operator to perform remote assistance for a vehicle is disclosed. The remote operator terminal includes a display device and processing circuitry configured to generate a remote assistance screen in response to remote assistance requests assigned to the remote operator. The remote assistance screen includes monitoring images showing an assistance situation of a target vehicle. The processing circuitry is further configured to set a display priority for each of the remote assistance requests, to select, as a preferential monitoring image, a monitoring image corresponding to a remote assistance request having a highest display priority among the monitoring images, and to display the monitoring images on the remote assistance screen so that the preferential monitoring image has higher noticeability than other monitoring images have.

### CROSS-REFERENCE TO RELATED APPLICATION

This application claims priority to Japanese Patent Application No. 2024-063642 filed on Apr. 10, 2024, the entire contents of which are incorporated by reference herein.

### TECHNICAL FIELD

The present disclosure relates to remote assistance for a vehicle.

### BACKGROUND ART

Recently, technique in which an operator of a vehicle remotely operates the vehicle from a remote place has been known. In typical remote control of a vehicle, images captured by an in-vehicle camera are displayed on a terminal for the operator to perform remote control. The operator performs remote control of the vehicle while checking the situation of the vehicle shown in the images displayed on the terminal.

For example, Patent Document 1 discloses a remote monitoring control device that displays, on a display unit, at least one of a monitoring screen displaying an image (video data) captured by a camera for each of a plurality of moving bodies and a remote control screen displaying an image (video data) related to a remote-controlled moving body determined to be incapable of autonomous driving among the plurality of moving bodies. Further, Patent Literature 1 discloses a technique in which a remote control screen is displayed in a more emphasized way than a monitoring screen. In addition, other prior art, such as the following Patent Literatures 2 and 3, show the technical level of the present technical field.

### LIST OF RELATED ART

Patent Literature 1: Japanese Patent No. 7290199
Patent Literature 2: Japanese Patent Application Laid-Open No. 2021-082295
Patent Literature 3: Japanese Patent Application Laid-Open No. 2020-161039

### SUMMARY

Vehicle remote control is applied to vehicle remote assistance. In the vehicle remote assistance, a remote assistance request for requesting support by an operator is transmitted from a target vehicle. Then, the operator to which the remote assistance request is assigned performs remote assistance for the target vehicle, which has transmitted the remote assistance request.

In particular, in vehicle remote assistance, it is considered that a plurality of remote assistance requests can be assigned to one operator in order to make the assistance more efficient, to reduce its labor cost, etc. When a plurality of remote assistance requests is assigned to one operator, plurality of images related to each of the plurality of remote assistance requests is displayed on the terminal of the operator. Prior art has not sufficiently been studied how to display each image on the terminal in such a case. For example, when the technique disclosed in Patent Literature 1 is applied, a plurality of highlighted images is displayed in a case where multiple target vehicles are determined to be incapable of autonomous driving. The plurality of highlighted images may confuse the operator since he/she cannot determine which remote assistance request should be preferentially handled.

The present disclosure aims to solve the above-described problem. One purpose of the present disclosure is to provide a technique that enables an operator to whom a plurality of remote assistance requests is assigned to effectively perform remote assistance for each remote assistance request.

A first aspect of the present disclosure relates to a remote operator terminal for a remote operator to perform remote assistance for a vehicle.

The remote operator terminal includes a display device and processing circuitry, configured to generate a remote assistance screen for the remote operator to perform the remote assistance in response to one or more remote assistance requests assigned to the remote operator, and to display the remote assistance screen on the display device.

The remote assistance screen includes one or more monitoring images showing an assistance situation of a target vehicle for each of the one or more remote assistance requests.

The processing circuitry is further configured to set a display priority for each of the one or more remote assistance requests, to select, as a preferential monitoring image, a monitoring image corresponding to a remote assistance request having a highest display priority among the one or more monitoring images, and to display the one or more monitoring images on the remote assistance screen so that the preferential monitoring image has higher noticeability than other monitoring images have.

A second aspect of the present disclosure relates to a remote assistance system for remote assistance for a vehicle.

The remote assistance system includes a remote operator terminal for a remote operator to perform the remote assistance and processing circuitry, configured to generate a remote assistance screen for the remote operator to perform the remote assistance in response to one or more remote assistance requests assigned to the remote operator, and to display the remote assistance screen on the remote operator terminal.

The remote assistance screen includes one or more monitoring images showing an assistance situation of a target vehicle for each of the one or more remote assistance requests.

The processing circuitry is configured to set a display priority for each of the one or more remote assistance requests, to select, as a preferential monitoring image, a monitoring image corresponding to a remote assistance request having a highest display priority among the one or more monitoring images, and to display the one or more monitoring images on the remote assistance screen so that the preferential monitoring image has higher noticeability than other monitoring images have.

According to the present disclosure, the display priority is set for each of one or more remote assistance requests. Then, the noticeability of the preferential monitoring image corresponding to the remote assistance request having the highest display priority in the remote assistance screen is set to be higher than those of the other monitoring images. This can draw the operator's attention to handle the remote assistance request related to the preferential monitoring image. That is, it is possible to prevent the operator's confusion, derived from the plurality of highlighted image, about which remote assistance request should be preferentially handled, leading to effective remote assistance for each remote assistance request.

### BRIEF DESCRIPTION OF DRAWINGS

FIG. 1 is a diagram showing an overall configuration of a remote assistance system according to an embodiment;

FIG. 2 is a diagram showing an example of assignment of a remote assistance request in the remote assistance support system according to the embodiment;

FIG. 3 is a diagram showing a configuration example of a remote operator terminal according to the embodiment;

FIG. 4 is a diagram showing an example of a remote assistance screen generated when one remote assistance request is assigned to a remote operator;

FIG. 5 is a diagram showing an example of a remote assistance screen generated when a plurality of remote assistance support requests is assigned to a remote operator;

FIG. 6 is a diagram showing an example of a remote assistance screen generated when the plurality of remote assistance support requests is assigned to the remote operator;

FIG. 7 is a diagram showing another example of the remote assistance screen generated when the plurality of remote assistance requests is assigned to the remote operator;

FIG. 8 is a diagram showing an example of the remote assistance screen generated in accordance with a display priority set for each remote assistance request.

### DETAILED DESCRIPTION

Hereinafter, embodiments of the present disclosure will be described with reference to the drawings. The same or corresponding parts in the drawings are denoted by the same reference numerals, and the description thereof will be simplified or omitted.

### 1. Remote Assistance System

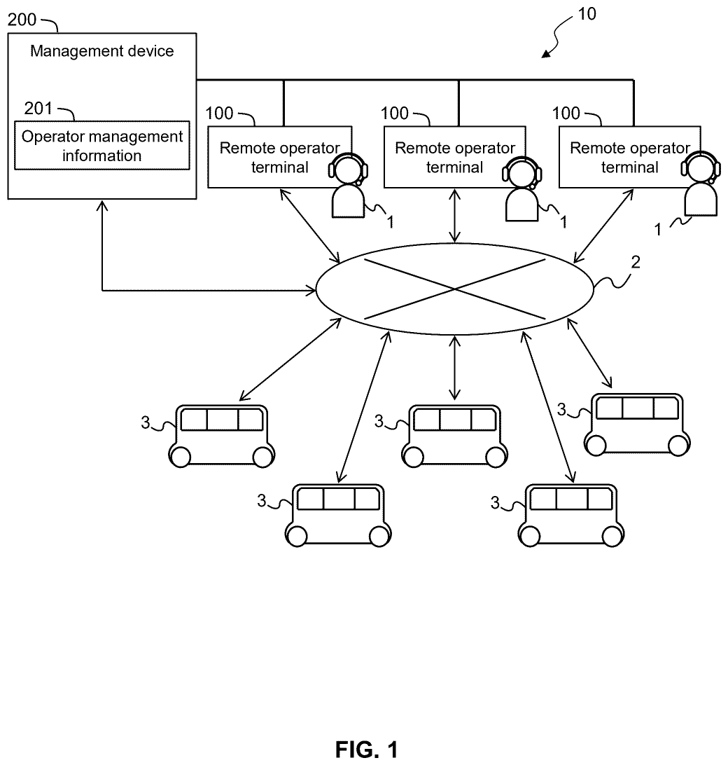

FIG. 1 is a diagram showing an example of an overall configuration of a remote assistance system 10 according to the present embodiment. The remote assistance system 10 includes a plurality of vehicles 3, a plurality of remote operator terminals 100, and a management device 200. Each vehicle 3, each remote operator terminal 100, and the management device 200 are configured to able to communicate with each other via a communication network 2. The communication network 2 is configured by, for example, the Internet, a moving body communication system, etc. The management device 200 is communicably connected to each remote operator terminal 100 in a wired or wireless manner. Each remote operator terminal 100 is operated by a remote operator 1. The remote assistance system 10 is a system for the remote operator 1 to perform remote assistance for the vehicle 3 via an operation of the remote operator terminal 100.

When the vehicle 3 is in a situation where assistance by the remote operator 1 is required, the vehicle 3 transmits a remote assistance request to the management device 200. The vehicle 3 is typically an autonomous driving vehicle. For example, when autonomous driving determination (for example, start, start of right or left turn, lane change, etc.) is difficult, the vehicle 3, as the autonomous driving vehicle, transmits a remote assistance request for driving determination to the remote operator 1. In particular, a case where the vehicle 3 is an autonomous driving vehicle used as a crewless public bus is considered. In this case, for example, when it is difficult to determine the situation of the passenger getting on and off at a bus stop, the vehicle 3, as the public bus, transmits a remote assistance request for requesting the remote operator 1 to determine to open or close the door. For another example, when a problem occurs in a passenger in the vehicle 3 as a public bus, the vehicle 3 transmits a remote assistance request for requesting the remote operator 1 to care the passenger (for example, to check safety in the vehicle 3, to make a call with the passenger, or to determine whether to report to an external organization). As described above, the remote assistance request transmitted from the vehicle 3 may be related to various assistance contents depending on the vehicle 3 or the situation of the vehicle 3. The remote assistance request includes at least identification information (ID) of the vehicle 3, a target of the remote assistance, and information of assistance content.

The management device 200 is a computer managing the remote assistance system 10. The management device 200 may be configured by a plurality of servers that perform distributed process.

The management device 200 stores operator management information 201. The operator management information 201 is information for managing a plurality of remote operators 1. The operator management information 201 indicates, for each remote operator 1, a remote assistance status, information of the remote operator terminal 100 being operated, identification information, a history of remote assistance performed, etc.

The management device 200 receives the remote assistance request from each vehicle 3 at any time. The management device 200 assigns the received remote assistance request to an appropriate remote operator 1 based on the operator management information 201. For example, the management device 200 acquires the remote assistance status of each remote operator 1 from the operator management information 201, and assigns the remote assistance request to the remote operator 1 that has not performed the remote assistance yet.

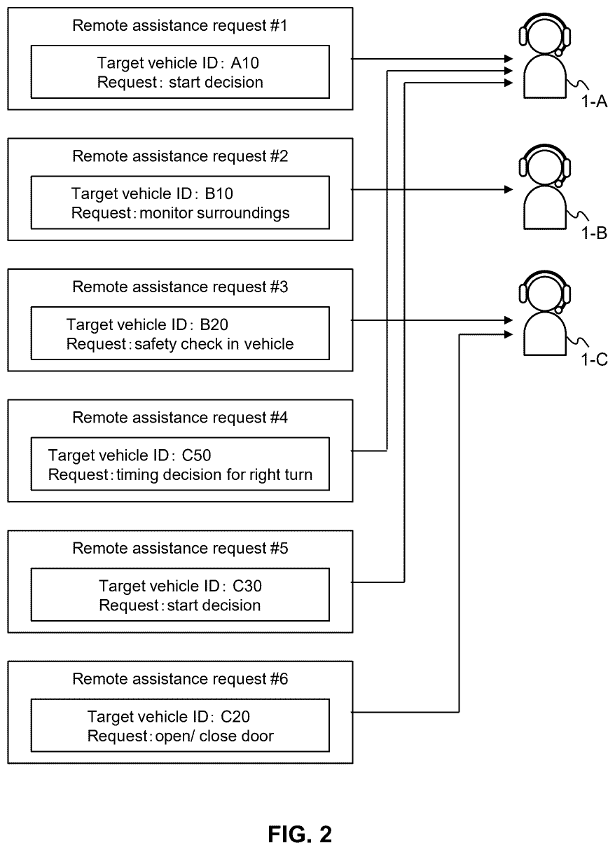

In the remote assistance system 10 according to the present embodiment, the management device 200 can assign a plurality of remote assistance requests to one remote operator 1. FIG. 2 is a conceptual diagram showing an example of assignment of a remote assistance request by the management device 200. The example in FIG. 2 illustrates a case where six remote assistance requests #1 to #6 are assigned to three remote operators 1-A, 1-B, and 1-C. In the example illustrated in FIG. 2, three remote assistance requests #1, #4, and #5 are assigned to the remote operator 1-A. Two remote assistance requests #3 and #6 are assigned to the remote operator 1-C. In this way, the management device 200 may assign a plurality of remote assistance requests to one remote operator 1.

After assigning the remote assistance request to the remote operator 1, the management device 200 notifies the remote operator terminal 100 operated by the remote operator 1 of information of the assigned remote assistance request. The remote operator terminal 100, which has received the notification, specifies the vehicle 3 that is a target of the remote assistance (hereinafter, referred to as a “target vehicle 3-X”), using the information of the remote assistance request, and starts to communicate with the target vehicle 3-X. Accordingly, the remote operator 1 can perform remote assistance of the target vehicle 3-X in response to the assigned remote assistance request via an operation of the remote operator terminal 100.

### 2. Remote Operator Terminal

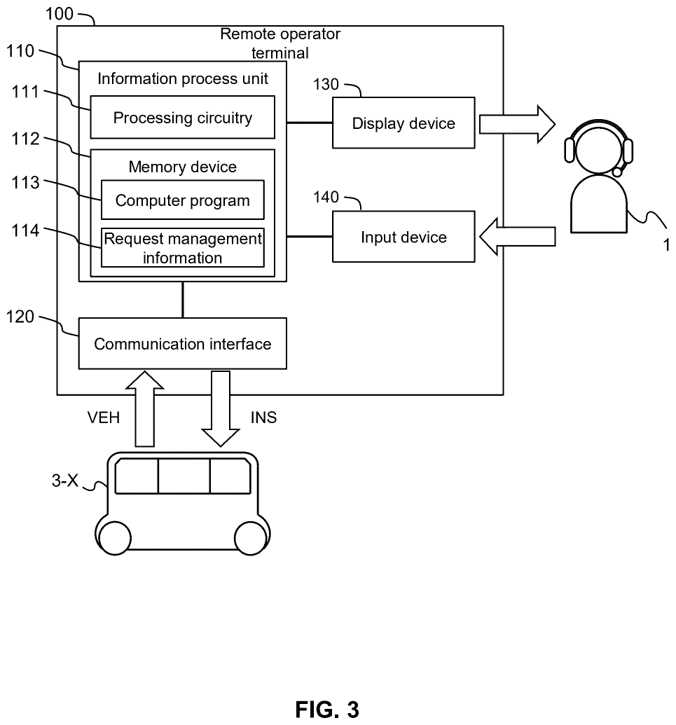

Hereinafter, the remote operator terminal 100 according to the present embodiment will be described in detail. FIG. 3 is a diagram showing a configuration example of the remote operator terminal 100 according to the present embodiment. The remote operator terminal 100 includes an information process unit 110, a communication interface (communication I/F) 120, a display device 130, and an input device 140.

The information process unit 110 executes a variety of information processes of the remote operator terminal 100. The information process unit 110 includes processing circuitry 111 and a memory device 112.

The processing circuitry 111 executes a variety of processes. The processing circuitry 111 may be configured as, for example, a general-purpose processor, a special-purpose processor, a central processing unit (CPU), a graphics processing unit (GPU), an application specific integrated circuit (ASIC), a field-programmable gate array (FPGA), an integrated circuit, a conventional circuit, or a combination of one or more of these. In general, a processor including transistors and other circuitry is an example of processing circuitry 111. The processing circuitry 111 may also be referred to as circuitry, programmed to implement or perform the functions described in this disclosure.

The memory device 112 stores a variety of information necessary for execution of processes by the processing circuitry 111. The memory device 112 is configured by a recording medium such as a random access memory (RAM), a read only memory (ROM), a solid state drive (SSD), or a hard disk drive (HDD). The memory device 112 stores a computer program 113 executable by the processing circuitry 111 and request management information 114. The computer program 113 is configured by a plurality of processes to be executed by the processing circuitry 111. The computer program 113 may be recorded in a computer-readable recording medium. The processing circuitry 111, which executes the computer program 113, and the memory device 112 cooperate with each other to realize the function of the information process unit 110. The request management information 114 manages a remote assistance request assigned to the remote operator 1 operating the remote operator terminal 100. The information process unit 110 can acquire the ID of the target vehicle 3-X and the assistance content of each remote assistance request assigned to the remote operator 1 by referring to the request management information 114.

The communication I/F 120 is an interface to communicate with an external device of the remote operator terminal 100. The remote operator terminal 100 communicates with the vehicle 3 and the management device 200, via the communication I/F.

The display device 130 is a device for performing a variety of displays to the remote operator 1. The display of the display device 130 is controlled by the information process unit 110. The display device 130 is configured by a display, a touch screen, etc.

The input device 140 is a device for receiving a variety of inputs from the remote operator 1. The input received by the input device 140 is transmitted to the information process unit 110. The input device 140 is configured by a keyboard, a pointing device, a touch pad, a switch, etc.

Based on the above configuration, the remote operator terminal 100 realizes remote assistance of the target vehicle 3-X by the remote operator 1 as follows.

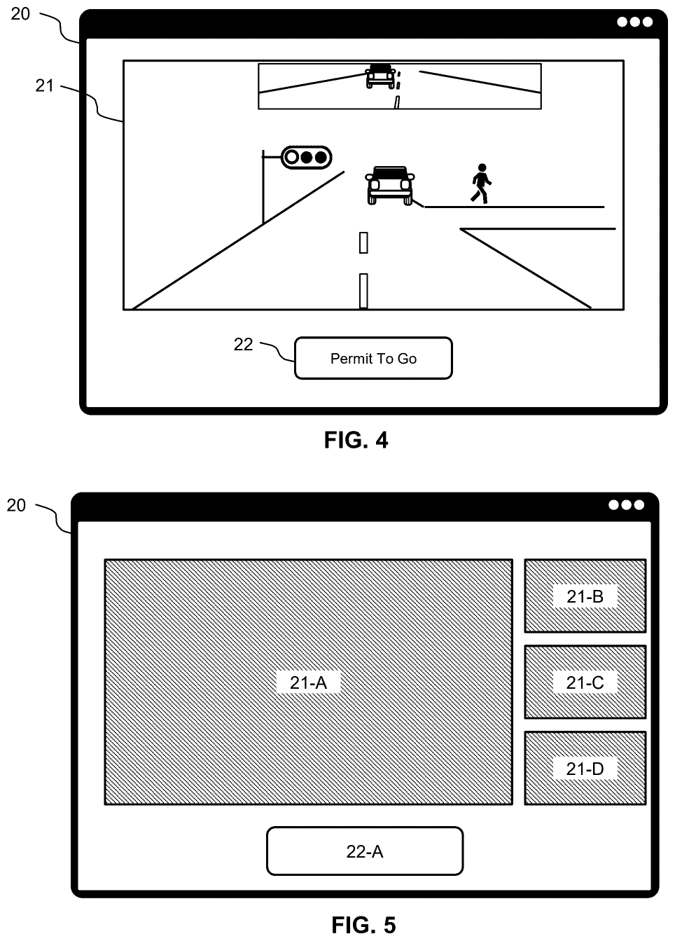

First, the information process unit 110 acquires the vehicle information VEH from the object vehicle 3-X via the communication I/F 120. The vehicle information VEH is information detected by a variety of sensors mounted on the target vehicle 3-X. The vehicle information VEH includes at least an image captured by an in-vehicle camera of the target vehicle 3-X. The in-vehicle camera of the target vehicle 3-X may include a plurality of cameras (for example, a front camera, a rear camera, a side camera, a vehicle interior camera, etc.) with different directions. The vehicle information VEH may further include a traveling state (for example, a speed, a steering angle, etc.) or a position of the target vehicle 3-X. Then, the information process unit 110 generates a remote assistance screen for the remote operator 1 to perform remote assistance in response to the remote assistance request assigned to the remote operator 1 and displays the remote assistance screen on the display device 130. FIG. 4 is a diagram illustrating an example of the remote assistance screen 20 displayed on the display device 130. FIG. 4 shows a case where one remote assistance request is assigned to the remote operator 1. The remote assistance screen 20 displayed when a plurality of remote assistance requests is assigned to the remote operator 1 will be described later.

The remote assistance screen 20 includes a monitoring image 21 displaying an assistance situation of the target vehicle 3-X and an operation icon 22 that accepts a remote assistance operation by the remote operator 1.

The monitoring image 21 is typically configured by an image captured by the in-vehicle camera of the target vehicle 3-X. The monitoring image 21 may be configured by a plurality of images. The monitoring image 21 shown in FIG. 4 is configured by two images captured by the front camera and the rear camera. The monitoring image 21 may be configured to further display information on the travel state and the position of the target vehicle 3-X.

The configuration of the monitoring image 21 is determined according to the assistance content of the corresponding remote assistance request. The information process unit 110 configures the monitoring image 21 based on the assistance content of the corresponding remote assistance request and the vehicle information VEH. In the example shown in FIG. 4, it is assumed that the assistance content of the corresponding remote assistance support request is “start determination”. In this case, the information process unit 110 configures the monitoring image 21 by at least the image captured by the front camera as illustrated in FIG. 4. On the other hand, a case where the assistance content of the corresponding remote assistance support request is “safety check in the vehicle” is considered. In this case, the information process unit 110 configures the monitoring image 21 by at least an image captured by the vehicle interior camera.

The remote assistance operation accepted by the operation icon 22 is typically an operation in which the remote operator 1 determines the assistance content of the remote assistance request. Therefore, the configuration of the operation icon 22 is also determined according to the assistance content of the corresponding remote assistance request. The information process unit 110 configures the operation icon 22 based on the content of the corresponding remote assistance request. In the example shown in FIG. 4, a “Permit To Go” icon for performing start determination is shown as the operation icon 22. The remote operator 1 can determine for the start determination by performing an operation of pressing the “Permit To Go” icon as appropriate. On the other hand, a case where the assistance content of the corresponding remote assistance request is “opening/closing of passenger door” is considered. In this case, the information process unit 110 configures the operation icon 22 with, for example, a “door opening” icon and a “door closing” icon. The remote operator 1 can determine on “opening of the passenger door” by appropriately performing an operation of pressing each of the “door opening” icon and the “door closing” icon.

In this way, the remote operator 1 checks the assistance situation of the target vehicle 3-X from the monitoring image 21 of the remote assistance screen 20 displayed on the display device 130. The remote operator 1 performs a remote assistance operation in response to the remote assistance request by operating the operation icon 22 of the remote assistance screen 20 via the input device 140.

With reference to FIG. 3, the information process unit 110 determines the remote assistance operation of the remote operator 1 in response to the remote assistance request based on the input received by the input device 140. The information process unit 110 generates the instruction information INS in response to the remote assistance operation by the remote operator 1. The instruction information INS indicates permission to start, for example, answering to the remote assistance request of “start determination”. Then, the information process unit 110 transmits the generated instruction information INS to the target vehicles 3-X via the communication I/F 120. The target vehicle 3-X operates in accordance with the received instruction information INS. For example, the target vehicle 3-X starts in response to the reception of the instruction information INS indicating the permission of starting.

In this way, the remote operator terminal 100 according to the present embodiment realizes remote assistance of the target vehicle 3-X by the remote operator 1.

In the above description, an example of the remote assistance screen 20 displayed on the display device 130 has been described for the case where one remote assistance request is assigned to the remote operator 1 (see FIG. 4). As described above, in the remote assistance system 10 according to the present embodiment, the management device 200 can assign a plurality of remote assistance requests to one remote operator 1. The remote assistance screen 20 generated by the information process unit 110 when a plurality of remote assistance requests is assigned to the remote operator 1 will be described below.

### 3. Generation of Remote Assistance Screen for a Plurality of Remote Assistance Requests

When a plurality of remote assistance requests is assigned to the remote operator 1, the information process unit 110 generates the remote assistance screen 20 including the monitoring image 21 corresponding to each remote assistance request. That is, the remote assistance screen 20 is generated so as to include the plurality of monitoring images 21. Each monitoring image 21 displays the assistance situation of the target vehicle 3-X of the corresponding remote assistance request.

Here, the display of the plurality of monitoring images 21 on the remote assistance screen 20 will be considered. If the plurality of monitoring images 21 are displayed uniformly (i.e. without any highlight or highlighted in the same way) on the remote assistance screen 20, the plurality of images may confuse the operator since he/she cannot determine which remote assistance request should be preferentially handled. This may lead to an erroneous operation or an erroneous determination by the remote operator 1.

Therefore, the information process unit 110 sets a “display priority” to each of the plurality of remote assistance requests assigned to the remote operator 1. The information process unit 110 further selects one monitoring image 21 corresponding to the remote assistance request having a highest display priority among the plurality of monitoring images 21 (hereinafter, the selected monitoring image 21 is referred to as a “preferential monitoring image”). The information process unit 110 is configured to display the plurality of monitoring images 21 so that the preferential monitoring image has higher noticeability than those of the other monitoring images 21 on the remote assistance screen 20.

This can draw the remote operator 1's attention to preferentially handle the remote assistance request related to the preferential monitoring image. That is, it is possible to prevent the remote operator 1's confusion about which remote assistance request should be preferentially handled, caused by the plurality of monitoring image 21. Further, the remote assistance screen 20 includes the monitoring image 21 corresponding to each remote assistance request, and thus the remote operator 1 can easily recognize the assignment situation of the remote assistance request to the remote operator 1 with the remote assistance screen 20. As a result, erroneous operations and erroneous determinations by the remote operator 1 can be prevented, and the remote operator 1 can effectively perform remote assistance in response to each remote assistance request. The remote assistance request corresponding to the preferential monitoring image is specifically referred to as “preferential request”.

The “display priority” set to the remote assistance request can be said to be a priority for displaying the monitoring image 21 corresponding to the remote assistance request as the preferential monitoring image. The information process unit 110, for example, can set the display priority of each remote assistance request in the basis of the order in which the remote assistance requests are assigned. From this viewpoint, the information process unit 110 sets the display priority higher for a remote assistance request assigned earlier. Therefore, in this viewpoint, the monitoring image 21 is displayed as the preferential monitoring image in the order in which the remote assistance requests are assigned. That is, the remote operator can be prompted to handle the remote assistance request earlier in the assigned order.

The information process unit 110 may be configured to set the display priority of each remote assistance request based on other viewpoints. For example, from the viewpoint of the assistance situation of the remote assistance request, the information process unit 110 sets the display priority of the remote assistance request for requesting only the situation check of the remote assistance to be lower. As another option, the information process unit 110 may be configured to randomly set the display priority of each remote assistance request.

FIGS. 5 to 7 are diagrams showing specific examples of the remote assistance screen 20 generated by the information process unit 110 when a plurality of remote assistance requests are assigned to the remote operator 1. In FIGS. 5 to 7, the remote assistance screen 20 includes four monitoring images 21-A, 21-B, 21-C, and 21-D. That is, four remote assistance requests are assigned to the remote operator 1. In particular, it is assumed that the display priorities set in the remote assistance requests corresponding to the monitoring images 21-A, 21-B, 21-C, and 21-D are high in this order (21-A>21-B>21-C>21-D). Therefore, FIGS. 5 to 7 show a case where the monitoring image 21-A is selected as the preferential monitoring image. In this case, the remote assistance request corresponding to the preferential monitoring image 21-A is the preferential request.

FIG. 5 shows a specific example in which the size of each monitoring image 21 is modified to make the noticeability of the preferential monitoring image higher than those of the other monitoring images 21. In the example shown in FIG. 5, the size of the monitoring image 21-A is larger than the other monitoring images 21-B, 21-C, and 21-D. Accordingly, it is clear that the noticeability of the monitoring image 21-A, which is the preferential monitoring image, is higher than the noticeability of the other monitoring images 21-B, 21-C, and 21-D.

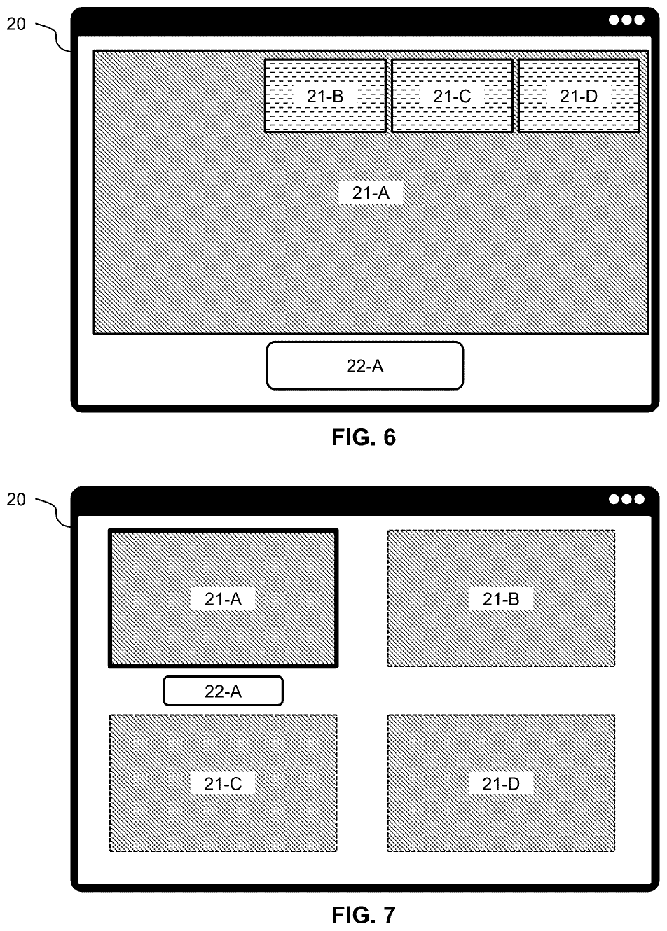

FIG. 6 is a specific example of a case where the noticeability of the preferential monitoring image is set higher than those of the other monitoring images 21 by modifying arrangement of the monitoring images 21. In the example shown in FIG. 6, the monitoring image 21-A is arranged at the center, and the other monitoring images 21-B, 21-C, and 21-D are overlappingly arranged in windows at the upper right on the monitoring image 21-A. Accordingly, it is clear that the noticeability of the monitoring image 21-A which is the preferential monitoring image is higher than the noticeability of the other monitoring images 21-B, 21-C, and 21-D.

FIG. 7 shows a specific example in which the noticeability of the preferential monitoring image is made higher than the noticeability of the other monitoring images 21 by modifying outer frame appearance of each monitoring image 21. In the example illustrated in FIG. 7, the outer frame of the monitoring image 21-A is shown thicker, and the outer frames of the other monitoring images 21-B, 21-C, and 21-D thinner. Alternatively, the outer frame of the monitoring image 21-A may be colored with high visual attraction (for example, colored red, yellow, orange, etc.), and the outer frames of the other monitoring images 21-B, 21-C, and 21-D may be colored with lower visual attraction (for example, blue, light blue, purple, etc.). Accordingly, it is clear that the noticeability of the monitoring image 21-A, which is the preferential monitoring image, is higher than the noticeability of the other monitoring images 21-B, 21-C, and 21-D.

The specific examples shown in FIGS. 5 to 7 can be combined. For example, in the example illustrated in FIG. 5, the outer frame of the monitoring image 21-A may be shown thicker, and the outer frame of the other monitoring images 21-B, 21-C, and 21-D may be shown thinner. The combination of modification can further enhance the noticeability of the preferential monitoring image.

As described above, the information process unit 110 can be configured to generate the remote assistance screen 20 in which the noticeability of the preferential monitoring image is set to be higher than those of the other monitoring images 21 by modifying at least one of the size, the arrangement, and the outer frame appearance of each monitoring image 21.

In the examples illustrated in FIGS. 5 to 7, the remote assistance screen 20 includes an operation icon 22-A. The operation icon 22-A is an operation icon 22 for receiving a remote assistance operation by the remote operator 1 in response to a remote assistance request corresponding to the monitoring image 21-A, the preferential monitoring image. On the other hand, the remote assistance screen 20 does not include the operation icon 22 that receives a remote assistance operation by the remote operator 1 in response to the other remote assistance request. In this way, the information process unit 110 may be configured to generate the remote assistance screen 20 including only the operation icon 22 related to the remote assistance request corresponding to the preferential monitoring image. In other word, the remote assistance screen includes the operation icon 22-A, corresponding to the preferential request, but does not include an operation icon to receive a remote assistance operation for the other remote assistance requests. With such a configuration, erroneous operation and erroneous determination by the remote operator 1 can be prevented more effectively.

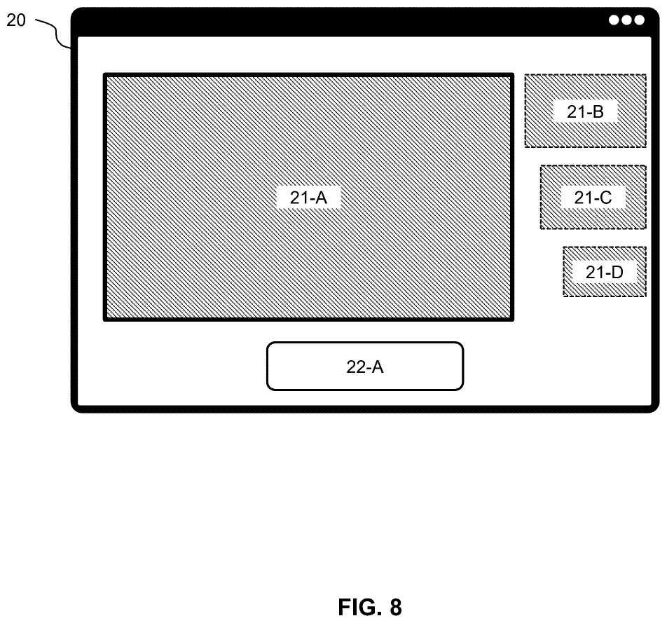

The information process unit 110 may be configured to modify the noticeability of the monitoring image 21 other than the preferential monitoring image on the remote assistance screen 20 in accordance with the display priority set to each remote assistance request. In particular, the information process unit 110 may be configured to set the noticeability of the monitoring image 21 higher as the display priority set in the remote assistance request is higher. FIG. 8 is a specific example of a case where the noticeability of the monitoring image 21 other than the preferential monitoring image is modified in accordance with the display priority set to each remote assistance request. FIG. 8 shows the same case as FIGS. 5 to 7. In the example shown in FIG. 8, the sizes of the monitoring images 21-B, 21-C, and 21-D, which are not the preferential monitoring image, are shown larger in this order, meaning that the other monitoring images 21-B, 21-C, and 21-D have higher noticeability in this order (21-B>21-C>21-D). This configuration enables the remote operator 1 to easily recognize the monitoring image 21 of the remote assistance request to be handled next. As a result, the noticeability of the remote operator 1 can be improved.

The information process unit 110 may be further configured to accept a “switching operation” by the remote operator 1 with respect to each monitoring image 21 other than the preferential monitoring image on the remote assistance screen 20. The information process unit 110 may be configured to switch the preferential monitoring image to the monitoring image 21 subjected to the switching operation, in response to the switching operation by the remote operator 1 to any one of the monitoring images 21. The switching operation is a predetermined operation, such as clicking on the monitoring image 21, mouseover on the monitoring image 21, etc. Further, for example, the information process unit 110 may display a switching icon for each monitoring image 21 other than the preferential monitoring image on the remote assistance screen 20. In this case, the information process unit 110 may accept operation of a switching icon displayed in correspondence with each monitoring image 21 as the switching operation. The information process unit 110 can determine whether or not the switching operation has been performed by the remote operator 1 based on the input received by the input device 140.

This configuration enables the remote operator 1 to switch the preferential monitoring image and handle the remote assistance request related to the “new” preferential monitoring image selected by the switching operation. This configuration is particularly effective when there is some time to spare until the remote assistance request related to the current preferential monitoring image can be handled, resulting in higher efficiency of remote assistance. In the present embodiment, the preferential monitoring image is selected in accordance with the display priority of each remote assistance request set by the information process unit 110, thereby reducing confusion of the remote operator 1 about which remote assistance request should be handled. On the other hand, the above-described configuration enables the remote operator 1 to arbitrarily select the preferential monitoring image, and then the remote operator 1 can handle the remote assistance request from a viewpoint different from the display priority set by the information process unit 110.

What is claimed is:

1. A remote operator terminal for a remote operator to perform remote assistance for a vehicle, the remote operator terminal comprising:
a display device; and
processing circuitry configured to generate a remote assistance screen for the remote operator to perform the remote assistance in response to one or more remote assistance requests assigned to the remote operator, and to display the remote assistance screen on the display device, wherein
the remote assistance screen includes one or more monitoring images showing an assistance situation of a target vehicle for each of the one or more remote assistance requests, and
the processing circuitry is further configured to:
set a display priority for each of the one or more remote assistance requests;
select, as a preferential monitoring image, a monitoring image corresponding to a remote assistance request having a highest display priority among the one or more monitoring images; and
display the one or more monitoring images on the remote assistance screen so that the preferential monitoring image has higher noticeability than other monitoring images have.

2. The remote operator terminal according to claim 1, wherein
the processing circuitry is further configured to:
set the noticeability of the preferential monitoring image to be higher than those of the other monitoring images by modifying at least one of size, arrangement, and outer frame appearance of each of the one or more monitoring images.

3. The remote operator terminal according to claim 1, wherein
a preferential request, included in the one or more remote assistance requests, is a remote assistance request corresponding to the preferential monitoring image, and
the remote assistance screen includes an operation icon to accept a remote assistance operation by the remote operator in response to the preferential request, whereas the remote assistance screen does not include an operation icon to accept a remote assistance operation by the remote operator for other remote assistance requests.

4. The remote operator terminal according to claim 1, wherein
a switching operation is a predetermined operation by the remote operator on any of the one or more monitoring images on the remote assistance screen other than the preferential monitoring image, and
the processing circuitry is further configured to, in response to the switching operation, switch the preferential monitoring image to the one subjected to the switching operation.

5. A remote assistance system for remote assistance for a vehicle, the remote assistance system comprising:
a remote operator terminal for a remote operator to perform the remote assistance; and
processing circuitry configured to generate a remote assistance screen for the remote operator to perform the remote assistance in response to one or more remote assistance requests assigned to the remote operator, and to display the remote assistance screen on the remote operator terminal, wherein
the remote assistance screen includes one or more monitoring images showing an assistance situation of a target vehicle for each of the one or more remote assistance requests, and
the processing circuitry is configured to:
set a display priority for each of the one or more remote assistance requests;
select, as a preferential monitoring image, a monitoring image corresponding to a remote assistance request having a highest display priority among the one or more monitoring images; and
display the one or more monitoring images on the remote assistance screen so that the preferential monitoring image has higher noticeability than other monitoring images have.
